(19) United States
(12) Patent Application Publication
(10) Pub. No.: US 2024/0182724 A1
(43) Pub. Date: Jun. 6, 2024

(54) COMPOSITION COMPRISING CARBON QUANTUM DOTS (CQD'S)

(71) Applicant: CAS Composite Applied Systems GmbH, Nettetal (DE)

(72) Inventor: Wolfgang Schwarz, Vienna (AT)

(21) Appl. No.: 18/285,080

(22) PCT Filed: Mar. 29, 2022
(86) PCT No.: PCT/EP2022/058193

§ 371 Date: Sep. 29, 2023

(30) Foreign Application Priority Data
Mar. 29, 2021 (DE) 10 2021 107 867.9

(51) Int. Cl. C09D 5/22; C09D 1/06

(52) U.S. Cl. CPC C09D 5/22; C09D 1/06

(57) ABSTRACT

Provided is a composition for construction purposes comprising 0.001-2 wt.-% of carbon quantum dots. Further provided is the use of the composition in a paint, coating agent, binder, concrete or mortar.

### CROSS-REFERENCE TO RELATED APPLICATIONS

This application is a U.S. national stage application, filed under 35 U.S.C. § 371 (c), of International Application No. PCT/EP2022/058193, filed on Mar. 29, 2022, which claims priority to German Patent Application No. 10 2021 107 867.9, filed on Mar. 29, 2021. The entire contents of each of the aforementioned applications are incorporated herein by reference.

### BACKGROUND OF INVENTION

The present disclosure relates to compositions containing carbon quantum dots (CQD's). The content of CQD's causes a specific modification of the properties of the solid mixture such as electrical conductivity, ionic conductivity, polarization resistance, adhesion to solid substrates measured as adhesive tensile strength, galvanic currents of galvanic metal anodes, preferably zinc anodes, etc.

Advantageously, changes in material properties such as strength, adhesive tensile strengths, electrical conductivity and changes in electrochemical properties such as ionic conductivity, polarization resistance, galvanic activity of galvanic metal anodes, preferably zinc anodes.

According to a generally accepted definition, a quantum dot (QD) is a nanoscopic material structure. Charge carriers (electrons, holes) in a quantum dot are re-stricted in their mobility in all three spatial directions to such an extent that their en-ergy no longer takes on continuous but only discrete values. Typically, their own atomic scale is about 104 atoms. Multiple QD's can combine to form agglomerates quantum dot molecules [Somnath Koley, Jiabin Cui, Yossef E. Panfil, and Uri Banin, acc. Chem. Res. (2021), 54, 5, 1178-1188]. Quantum dots are miniature crystals with edge lengths of about three nanometers that can be excited to fluoresce with short-wavelength light, just like a single atom. The color in which a quantum dot glows depends on its size: A crystal with diameters of two nanometers emits shorter wavelength light than one made of the same atoms with diameters of eight nanometers [Qin Hu, Xiaojuan Gong, Lizhen Liu, and Martin M. F. Choi, Hindawi, Journal of Nanomaterials (2017), Volume 2017, Article ID

Carbon quantum dots (CQD's) are a new class of fluorescent carbon nanomaterials, they possess the attractive properties of high stability, good conductivity, low toxicity, environmental friendliness, simple synthetic routes, and comparable optical properties to quantum dots. CQD's are widely used in biomedical, optronics, catalysis and sensing applications due to their strong and tunable fluorescence emission properties [Wang, Youfu; Hu, Aiguo (2014). Journal of Materials Chemistry C. 2 (34), 6921]. CQD's can also be obtained from everyday materials such as polyethylene glycol (PEG), polyvinylpyrrolidone (PVP), bovine albumin, ascorbic acid, citric acid, chitosan, carregan powder, among others. [Wang, Youfu; Hu, Aiguo (2014) Journal of Materials Chemistry C (2014), 2, 69213][Raz Jelinek, Carbon Quantum Dots, Springer International Publishing Switzerland, Apr. 22, 2018]. Furthermore, CQD's are commercially available, e.g., from Sigma-Aldrich Co. (a subsidiary of Merck KGaA) as a 0.2% aqueous colloid with a quantum effi-ciency of 5% and a fluorescence Iₑₘ 450-550 nm.

Nothing is yet known about the use of CQD's to modify materials and material properties, in particular compositions for construction purposes of mixtures, especially of solids and/or of electrolytes, for example their improvement of conductivity and polarization resistance, their strength or adhesion to solid substrates.

### BRIEF DESCRIPTION OF THE DISCLOSURE

According to one aspect of the disclosure a composition for construction purposes comprising 0.001-2 wt.-% carbon quantum dots, based on the total weight of the composition.

In addition to one or more of the features described herein, or as an alternative, further embodiments of the composition may include the composition being a paint, coating agent, binder, concrete or mortar.

In addition to one or more of the features described herein, or as an alternative, further embodiments of the composition may include the composition comprises 0.005-0.5 wt.-%, preferably 0.05-0.2 wt.-%, of carbon quantum dots, based on the total weight of the composition.

In addition to one or more of the features described herein, or as an alternative, further embodiments of the composition may include the composition being liquid and curing at room temperature within one week.

In addition to one or more of the features described herein, or as an alternative, further embodiments of the composition may contain one or more compounds selected from the group composed of silicate, silicium dioxide, aluminate, aluminosilicate, graphite, carbonate, resin, silicone, cellulose and organic polymer.

In addition to one or more of the features described herein, or as an alternative, further embodiments of the composition may contain at least 30 wt.-% of the one or more compounds, based on the total weight of the composition.

In addition to one or more of the features described herein, or as an alternative, further embodiments of the composition may comprise one or more aluminosilicates having the formula aM₂O*bAl₂O₃*CSiO₂, wherein the molar ratio c/b is 0.1-15 and the molar ratio a/b is 0, 2-10, with M=Li, Na, K and/or characterized in that the composition comprises one or more aluminosilicates comprising calcium, wherein the molar ratio SiO₂/Al₂O₃ is <25 and the molar ratio SiO₂/(CaO+Al₂O₃) is <10.

In addition to one or more of the features described herein, or as an alternative, further embodiments of the carbon quantum dots fluoresce upon stimulation with UV light in the wavelength band 400 to 600 nm.

In addition to one or more of the features described herein, or as an alternative, further embodiments of the composition may be disposed in a construction material.

In addition to one or more of the features described herein, or as an alternative, further embodiments of the composition may be disposed in a paint, coating agent, binder, concrete or mortar.

### DETAILED DESCRIPTION OF THE DISCLOSURE

It is desirable to provide a composition whose conductivity and polarization resistance as well as its adhesion to solid substrates are improved and which can be used in particular for construction purposes.

This may be solved by a composition according to claim 1. Preferred embodiments of the composition are given in the subclaims.

Surprisingly, it was shown that material properties, in particular of solids, can be specifically modified by low to very low contents of CQD's, such as electrolytic and/or electrical conductivity, polarization resistance, adhesive tensile strengths, compressive strengths, elasticity, ductility, activity of galvanic metal anodes, preferably zinc anodes, etc., embedded in the solid according to embodiments of the invention.

The addition of even small amounts of CQDs to mixtures causes significant changes in the material properties, for example of solid mixtures but also of electrochemical systems containing CQD-containing electrolyte solutions and/or electrodes.

The compositions according to embodiments of the invention preferably contain at least one chemical compound or a mixture of chemical compounds selected from inorganic chemical substances such as silicates, silicium dioxide (silica), alumi-nates, aluminosilicates, carbonates, carbon, graphite, etc., from organic chemical substances such as polymers (e.g. polyamide, polyurethanes, etc.), resins (acrylic resins, epoxy resins, etc.), cellulose, silicones, silicone rubber, etc. They may also contain metals in the form of powders, fibers, etc. The solid according to embodiments of the invention has at least one property selected from hard, soft, brittle, elastic, plastic, deformable.

Preferably, the composition for construction purposes according to embodiments of the invention is a construction material, in particular an artificial construction material. Preferably, the composition according to embodiments of the invention for construction purposes is a paint, coating agent, binder, concrete or mortar.

Preferably, the composition for construction purposes according to embodiments of the invention is liquid, in particular viscous. Preferably, the composition cures at room temperature within three weeks, more preferably within one week, most preferably within four days. The content of CQD's can be achieved by impregnating the solid mixture, for example with a liquid in which the CQD's are suspended, preferably colloidal. Another method according embodiments of to the invention is to add the CQD's during the production of the solid, for example to the raw material or raw materials from which the solid according to embodiments of the invention is produced. Preferably, the CQD's are added to the raw material or raw materials as a suspension, preferably as a colloid, in a suitable liquid. Another preferred method is to add suitable substances to the raw material or raw materials so that the CQD's are formed in situ during the production or formation of the mixture according to embodiments of the invention.

CQD's usually have a size of 1-10 nm, they can agglomerate to CQD molecules, with particle sizes up to 100 nm. For simplicity, both singular and CQD agglomerates, such as CQD molecules, will be referred to as CQD's in the following.

The CQD's preferably have a particle size of >1 nm, preferably of >3 nm. They contain carbon and when excited with electromagnetic radiation, e.g. UV light, they emit fluorescent light in the wavelength range from 380 nm to 700 nm, preferably in the wavelength range from 400 nm to 600 nm. Agglomerates of CQD's—so-called quantum dot molecules—behave as CQD's and are referred to as such, but may have particle sizes >10 nm as quantum dot molecules. For the purposes of the disclosed embodiments of the invention, UV light is understood to mean light with a wavelength <400 nm, in particular light with a wavelength of 100-380 nm.

In a preferred embodiment, an embodiment of the invention is characterized by the fact that material properties selected from strength, adhesive strength, electrolytic conductivity, polarization resistance, galvanic activity of embedded metal electrodes and electrical conductivity are specifically modified by the content of CQDs, the selection given being exemplary and not exhaustive.

CQD's in the sense of the disclosed embodiments of the invention are CQD's according to the prior art as already described, and for example described in Raz Jelinek, Carbon Quantum Dots, Springer International Publishing Switzerland, Apr. 22, 2018.

Preferably, the CQD's are prepared in the medium in which the CQD's are ad-mixed to the raw material(s) or with which the solid is impregnated. One of several methods of preparing a CQD suspension according to embodiments of the invention comprises the step of synthesizing the CQD's from the medium in which they are subsequently suspended. The medium is thus both the liquid in which the CQD's are suspended and at least one of the raw materials from which the CQD's are prepared. One such medium is, for example, polyether from which CQD's are produced by oxidative polycondensation, as is generally known. For this purpose, for example, polyethylene glycols (PEG) are mixed with alkali hydroxides. The PEGs condense around the alkali ion to form polycyclic aromatics and subsequently CQD's. Details are described, for example, in Ji Chen, S. K. Spear, J. G., Huddleston and R. D. Rogers, “Polyethylene glycol and solutions of polyethylene glycol as green reaction media”, Green Chem., 2005, 7, 64-82.

Good results were obtained using polyethylene glycol as polyether, where the properties of the formed CQD's could be controlled via the cation (e.g. Li, Na, K, Rb, Cs) and the concentration of the added alkali hydroxide. CQD colloids prepared in this way showed fluorescence in the range of 380 to 600 nm, especially 400-600 nm, preferably with a peak in the range of 450 nm to 550 nm.

CQD suspensions or colloids prepared in this way had a CQD content of 0.1 wt. %. to 10 wt. %, approximately determined via the known molar extinction coefficient of 1.2×10⁶ M⁻¹ cm⁻¹ at 265 nm.

When introduced into an electrically conductive coating according to EP 1 068 164 A1 (Example 1), it was surprisingly shown that a content of CQD's significantly increases both the electrical conductivity and the adhesive tensile strengths of the coating on concrete and furthermore not only increases the electrolytic conductivity of the concrete cover, to which the conductive coating was applied not only increases but also stabilizes the electrolytic conductivity in a dry environment (45% relative humidity), so that it decreases much less than in the absence of CQD's (Examples 1-7).

Surprisingly, even low to very low levels of CQD's have an effect on the material properties. Already a content of 0.5% of a 0.5% CQD suspension in polyethylene glycol caused significant increase of the adhesive tensile strength (from 0.4 to 1.2 MPa), a decrease of the electrical sheet resistance of the coating (100 Ohm/square to 25 Ohm/square) (example 1). Even contents of 0.08% have a advantageous effect on both polarization resistances (DC resistance) and adhesive tensile strengths (Example 6).

The composition for construction purposes according to embodiments of the invention comprises 0.001-2 wt. % of carbon quantum dots, based on the total weight of the composition. Preferably, the composition according to embodiments of the invention comprises 0.005-0.5 wt. %, in particular 0.05-0.2 wt. %, of carbon quantum dots, based on the total weight of the composition.

Electrically conductive water vapor and gas permeable coatings on concrete, in particular if they are anodically polarizable, are used for corrosion protection of steel reinforcement. Ambient humidities of <65% relative humidity cause an increase in electrolytic resistance in the surface area of the concrete to which the electrically conductive coating is applied. The cause is drying of the surface area of the concrete due to water vapor diffusion, possibly enhanced by electroosmosis.

The drying of the concrete/coating interface also causes an increase in polarization resistance, which can be measured as part of the DC resistance. Part of the polarization resistance is also the transfer resistance from the electrode to the electrolyte. Increasing the electrolytic resistance of the concrete cover and the polarization resistance decreases the effectiveness of the corrosion protection of the steel reinforcement by decreasing the current flow between the conductive coating and the steel reinforcement. In addition, this can lead to concrete damage at the electrically conductive coating/concrete interface as a result of acid attack on the concrete by anodically formed acid.

For the electrochemical application of electrically conductive coatings on concrete, such as for corrosion protection of steel in concrete, not only the electrolytic resistance of the concrete is important, but also the polarization resistance of the electrodes—anode and cathode. The total resistance includes the polarization resistance and the electrolytic resistance. The electrolytic resistance can be determined by impedance measurements, in concrete usually at 1 KHz. The polarization resistance is measured as a DC resistance by applying a DC voltage of e.g. 2-3 volts between the two electrodes and calculating the specific resistance via the measured DC current according to Ohm's law (Example 2). The resistance thus determined includes the polarization resistance and the electrolytic resistance. In the following, the DC resistance measured when a DC voltage is applied is referred to as the polarization resistance and in the examples as the DC resistance. The electrolytic concrete resistance measured at 1 KHz and 120 Hz is referred to as impedance.

Surprisingly, it was found that even a low content of CQD's, for example a CQD content of 0.005 wt.-%, based on the total weight of the composition used as a coating agent of a concrete test specimen, lead to a significant decrease in polarization resistance and an increase in adhesive tensile strengths when the coated and polarized concrete test specimens were stored at 50% relative humidity (Examples 1 & 2).

In the absence of CQD's suspended in the polyether, three times higher polarization resistance of the concrete was measured after 60 days when stored at 50% relative humidity compared to the polarization resistance of the concrete in the presence of 0.01% CQD's.

Further experiments showed that the results described above can generally be achieved with conductive coatings, preferably with conductive coatings containing carbon, for example selected from graphite, carbon black, graphene.

In a preferred embodiment, the composition for construction purposes according to embodiments of the invention contains one or more compounds selected from the group consisting of silicate, silica, aluminate, aluminosilicate, graphite, carbonate, resin, silicone, cellulose and organic polymer. Preferably, the composition contains at least 5 wt.-%, more preferably >20 wt.-%, most preferably 30-95 wt.-%, and most preferably 35-80 wt.-% of said one or more compounds consisting of silicate, silica, aluminate, aluminosilicate, graphite, carbonate, resin, silicone, cellulose, and organic polymer.

In a preferred embodiment of the invention, the composition contains one or more aluminosilicates having the formula aM₂O*bAl₂O₃cSiO₂, wherein the molar ratio c/b =0.1-15 and the molar ratio a/b=0.2-10, with M=Li, Na, K. Preferably, the molar ratios c/b are 1-11 and/or a/b is 0.5-3, with M=Li, Na, K. It is further preferred that the composition contains one or more aluminosilicates comprising calcium, preferably the molar ratio SiO₂/Al₂O₃ is <25, more preferably <20, preferably the molar ratio SiO₂/(CaO+Al₂O₃) is <10, more preferably <5, and preferably the molar ratio Ca/Si is <2, more preferably <1. The ratio for Mg-containing aluminosilicates, preferably the molar ratio SiO₂/(CaO+MgO+Al₂O₃) is <10, more preferably <5.

Good results were obtained with alumosilicate-containing conductive coatings adapted from EP 1 068 164 A1, with a molar ratio SiO₂/Al₂O₃ of the alumosilicates greater than 0.1 preferably >1 and an alumosilicate content greater than 1 wt.-%, preferably greater than 3 wt.-%.

Advantageous results could also be obtained if an aqueous suspension was applied to the concrete surface prior to application of the conductive coating to the concrete, in particular with a content of CQD's 0.01-2 wt. %, preferably of 0.05-1 wt. %, analogous to a “primer” or “undercoat” as described in Examples 3-5: After impregnation with an aqueous suspension containing 0.05% CQD's, the polarization resistance after 60 days of storage at 50% relative humidity was lower by a factor of 3 than in the comparative sample without CQD suspension (Example 3).

The properties of the solid mixture, in particular the polarization resistance, can thus also be specifically modified by impregnating the solid mixture, e.g. concrete.

Surprisingly, CQD impregnation was found to have a particular effect on polarization resistance (DC resistance) and much less on electrolyte resistance (impedance) (Example 4):

Compared to the reference sample (sample 1), the polarization resistance (DC resistance) decreases by a factor of 1.8 when the concrete surface is impregnated with a primer containing 0.05% CQD's and, correspondingly, the DC current flowing at an applied voltage of 2 volts increases by the same factor. The impendance, however, is only reduced by a factor of 1.2. If the concrete substrate is impregnated with polyether only, as in sample 4, the addition of CQD's to the same amount of polyether (sample 3) causes the polarization resistance (DC resistance) to decrease by a factor of 2, while the impedance decreases by a factor of only 1.3.

The influence of the amount of CQD's with which the concrete substrate is impregnated affects the extent of the reduction in polarization resistance as shown by the measurement results presented in Example 5:

In sample 2 in example 5, four times the amount of CQD's (0.2% CQD) was added to the primer compared to sample 2 in example 4 (as described above). Compared to the reference sample (sample 1), the polarization resistance (DC resistance) is reduced by a factor of 2.8, i.e. 1.6 times more than in example 4. Moreover, the decrease in polarization resistance follows the amount of CQD's added—sample 2-4: The polarization resistance decreases approximately proportional to the amount of CQD's added to the primer. Surprisingly, the impedance practically does not change at the higher amounts of added CQD's. The absolute values of the measured resistances and impedances, measured on different concrete test plates, cannot be compared because the electrolyte resistances of the different concrete plates differ significantly.

Surprisingly, a correlation between the amount of added CQD's and their effect on the polarization resistance could also be established (example 5): In general, the polarization resistance decreases with admixture of CQD's—comparison sample 1 with sample 2-4. The increase in polarization resistance correlates with the amount of CQD's and decreases with increasing concentration of CQD's—comparison sample 2, 3 and 4). Surprisingly, the admixture of the CQD's has no significant effect on the impedances—this indicates that the CQD's are active with re-gard to the polarization resistance, especially at the electrode/electrolyte interface (example 6).

This interpretation is confirmed by the results of determining the effectiveness of the CQD's on the type of polarization of the electrode—anodic or cathodic-, as shown in Example 7: In the absence of CQD's, as expected, no significant difference in polarization resistance is observed depending on whether anodic or cathodic polarization is used (pos. 1 & 2). In the presence of 0.08% CQD's, on the one hand, the polarization resistance decreases significantly from about 20 MOhm·cm to 6-8 MOhm·cm. However, it is surprising that the polarization resistance depends on the type of polarization—the CQD's have a significantly stronger effect at the cathode (5.9 MOhm·cm) than at the anode (8.2 MOhm·cm).

Surprising results were obtained from the adhesive tensile strength measurements 77 days after application of the conductive coating to the concrete impregnated with a primer containing CQD (Example 6): On the concrete impregnated with a CQD-containing primer, the adhesive tensile strengths were significantly higher at 5.2 MPa compared to 4.5 MPa on concrete impregnated with a CQD-free primer. In these measurements, the demolition occurred exclusively in the concrete-pieces of concrete up to 1 cm deep were torn out of the concrete slab. Surprisingly, this indicates that impregnation of concrete with CQD's lead to an increase in concrete strength.

Surprisingly, it was also shown that even low levels of CQD's significantly increase the activity of anodes, especially embedded zinc anodes (EZA's):

Galvanic anode systems such as those described in EP 2 313 352 A1 consist of a galvanic metal anode, preferably zinc, embedded in a binder containing alumino-silicate (example 9). The metal anode is preferably embedded in the binder as a grid. The binder contains additives to prevent or at least minimize passivation of the zinc anode. Typically, current densities in the range of up to 20 mA/m² are measured shortly after the galvanic zinc anode is put into operation, and after 3-6 months typically about 3-6 mA/m² of active zinc surface flow at 70% relative humidity.

Surprisingly, it was shown that already a content of 0.03 to 0.04 wt. % of CQD's in a coating agent, based on the total weight of the coating agent, added for example as 0.5% CQD colloid in polyalkyl ether, cause a significant increase in the galvanic activity of a zinc anode applied to a steel-reinforced test plate with a chloride content of 3 wt. % (Example 9, Samples 9.2. and 9.3. compared to Sample 1.4). Initial galvanic currents increased from 20 mA/m² to about 35 mA/m², and from 10 mA/m² to 12 mA/m² after 1 month at 75% relative humidity. Higher addition levels of CQD's increased both initial galvanic currents and galvanic currents after 1 month of operation:

At a content of 0.1% CQD's in the embedding medium, the galvanic currents are 11% higher at the beginning and 21% higher after 1 month compared to an embedding medium containing 0.035% CQD's. Compared to the reference sample 9.4, the initial current is 1.8 times higher and the galvanic current after 1 month of operation is 48% higher.

A blank test in which only the medium—polyether, without CQD's—was added showed a slight reduction in the galvanic activity of the zinc anodes. Thus, an addition of as little as 0.03 wt. % of CQD's produces a clear and significant effect: as the results shown in Example 9 indicate, the effect of the admixture of CQD's is comparable in the concentration range from 0.03 to 0.1%—it leads to a “boost” of the galvanic current over a period of about 3 weeks. After that, the concentration of CQD's begins to play a role in the activity of the EZ anode. The results indicate that for a permanent increase in the galvanic activity of the zinc anode (EZ anode), a concentration of at least 0.05 wt.-% CQD, preferably 0.1 wt.-% CQD is advantageous. At concentrations of ≤ 0.03 wt.-%, the galvanic activity equals that of the EZ anode without CQD addition after about 3 months. This result is confirmed by the results shown in Example 10: Although an EZ anode with a CQD content of 0.025% based on the binder shows an almost doubling of the galvanic currents after 1 day, after 2 weeks the currents are still about 50% higher than in the CQD-free EZ anode. After 3 months, however, the difference in galvanic activity is no longer significant.

The admixture of CQD's to the embedding binder also causes an increase in galvanic currents in the absence of chloride, as shown by the results presented in Example 11. The admixture of 0.05% CQD to the embedding medium causes an increase in the galvanic currents of an EZ anode, stored at 75% relative humidity, by 40% after 3 days and by 44% after 7 days of operation.

Chloride, as is generally known, has an activating effect on the galvanic activity of zinc anodes. In the absence of chloride, CQD's activate the EZ anode twice as strongly (Example 11) as in the presence of chloride (Example 9 and Example 10). This is of particular importance for the application of the EZ anode on concrete components repaired with repair mortar: prior art zinc anodes lose their effectiveness over time in the absence of chloride, which means that the chloride contaminated concrete also has to be removed behind the steel reinforcement, usually by high pressure water jetting, and replaced by repair mortar—a considerable addi-tional effort in terms of time and cost.

The activation of the EZ anode with CQD's allows a very simplified repair of struc-tural elements damaged by corrosion—only the concrete damaged by cracks and spalling has to be removed and replaced by repair mortar, but not the chloride-contaminated concrete behind the steel reinforcement—this means a high saving of costs and especially of time.

Another advantage of the CQD content is the increase in galvanic activity, associ-ated with a decrease in autocorrosion of the zinc anode. The autocorrosion was determined by comparing the weight loss due to the galvanic current, expressed in coulombs, with the actual weight loss. Furthermore, autocorrosion can be determined by the measured “open-circuit” potential of the zinc anode against a reference electrode—e.g. an Ag/AgCI, 3M KCl electrode—placed externally on the surface (Example 12). In the presence of autocorrosion, the values are in the range of −400 mV to −600 mV vs. Ag/AgCI; in the absence of autocorrosion, the values are close to the theoretical value of −1200 mV vs. Ag/AgCI, in any case more negative than −700 mV. Values between −1100 and −1200 mV vs. Ag/AgCI were measured.

Another advantage of zinc anodes with CQD contents >0.03 wt. % was a significantly lower sensitivity of the galvanic currents to the relative humidity of the ambient air. Storage of a galvanic zinc anode with a CQD content of 0.05 wt.-% at 46% relative humidity resulted in galvanic currents of about 2-4 mA/m² after 6 months of operation; in the absence of CQD's in the embedding binder, the galvanic currents were about 1 mA/m² (Example 13).

The low sensitivity of galvanic currents to external humidity brings enormous ad-vantages: In most concrete structures, it is not only the steel reinforcement near the surface that needs to be protected against corrosion, but also deeper-lying steel reinforcement that lies in a moist environment even in dry external air, especially in concrete contaminated with chloride. Reliable corrosion protection of the deep-lying steel reinforcement even in dry outdoor conditions is therefore a very great advantage.

Surprisingly, the admixture of CQD's also affected the strengths, especially the adhesive tensile strengths of the embedding binder used in Examples 9-13: As shown by the results presented in Examples 14 and 15.

Good results were obtained with binders according to EP 2 313 352 A1 (see Example 9), with a molar ratio of SiO₂/Al₂O₃<20, preferably <15, a weight ratio SiO₂/(CaO+MgO+Al₂O₃) of <10, preferably <5, a molar ratio of Ca/Si of <2 preferably of <1, and galvanic zinc alloy metal anodes.

The effect of already very low CQD contents not only on the properties of the composition according to embodiments of the invention itself but also on solids embedded in the solid mixture, such as metal anodes, or on solids in contact with the CQD-containing mixture, such as e.g. CQD-containing conductive coatings applied to concrete, indicates that the CQD's are mainly interfacially active, both at interfaces within the solid mixture, such as pores, grain boundaries, and at the interfaces of mixtures in contact with the CQD-containing solid, especially at elec-trode/electrolyte interfaces.

Suitable CQD's are for example described in Shouvik Mitra, Sourov Chandra, Sha-heen H. Pathan, Narattam Sikdar, Panchanan Pramanik and Arunava Goswami in RSC Advances (2013), 3, 3189-3193. Suitable CQD's include CQD's prepared by polycondensation of polyethers, carbohydrates, chitosan as noted above and as described in Persia Ada N. de Yro,a, Beejay T. Salon, Blessie A. Basilia, Mark Daniel de Luna and Peerasak Paoprasert, MATEC Web of Conferences (2016) 43, 4002; Hui Peng and Jadranka Travas-Sejdic, Chem. Mater. (2009), 21, 5563-5565; Youfu Wang, Aiguo Hu, Journal of Materials Chemistry C, (2014), 2, 6921, described as examples but not exhaustively. Surface-modified CQD's can be used to modify material properties particularly advantageously, such as N-doped CQD's [Xin Liu, Jinhui Pang, Feng Xu & Xueming Zhang, www.nature.com/scientificre-ports (2016) | 6:31100| DOI: 10.1038/srep31100].

A preferred preparation of CQD's that can be used in the compositions according to embodiments of the invention is based on the description in Ji Chen, S. K. Spear, J. G. Hauddleston and R. D. Rogers, “Polyethylene glycol and solutions of polyethylene glycol as green reaction medis”, Green Chem. (2005) 7, 64-82: Polyethylene glycol (PEG) is mixed with alkali hydroxide, e.g. KOH or LiOH. The PEGs condense around the alkali ion to form polycyclic aromatics and subsequently CQDs. CQD colloids with concentrations of up to 10 wt. % can thus be produced directly; further concentration and purification can be achieved by dialysis.

CQD's can be characterized by their optical properties, UV-VIS absorption spectrum and/or fluorescence spectrum, as described for example in [Qin Hu, Xiaojuan Gong, Lizhen Liu, and Martin M. F. Choi, Characterization and Analytical Separa-tion of Fluorescent Carbon Nanodots, Hindawi Journal of Nanomaterials, (2017) Volume 2017, Article ID 1804178, 1-23]. Typically, CQD's exhibit an absorption shoulder at about 260 nm with a molar extinction coefficient of about 1×10⁶ M⁻¹ cm⁻¹ and photoluminescence in the range of 350-700 nm with an emission maxi-mum in the range of 400-600 nm, depending on the particle size. The particle size of CQD's can vary from 1 to 10 nm, that of CQD molecules from 3 to 100 nm with an average molecular weight from 100 to 100,000 daltons, preferably from 500 to 50,000 daltons. Due to the particle size, CQD's and CQD molecules exhibit characteristic quantum effects. As defined at the outset, CQD's and CQD molecules are referred to herein as CQD's.

Via their characteristic photoluminescence spectra, CQDs allow the detection of, for example, iron (III) (rust), the determination of the pH value, nitrite, silver, mer-cury and copper. Solids with CQD contents according to embodiments of the invention thus allow the detection and determination of the substances and values listed above, on their surface or via suitable embedded optical sensors inside the solids according embodiments of to the invention.

Another application according to embodiments of the invention is the conferral of fluorescent properties by a content of QD's, preferably by a content of CQD's.

The change in solid properties due to a content of CQD's is based on the specific properties of the CQD's as QD's, in particular their quantum specific properties.

CQD's are easy and inexpensive to produce, the same or similar changes in solid properties can consequently also be achieved by QD's in general.

The modification of the properties of mixtures according to embodiments of the invention, in particular of solid mixtures by a content of CQD's can be generally applied to solid mixtures according to embodiments of the invention, as for example to their preparation and/or by their impregnation with CQD's, e.g. a CQD colloid.

Material properties such as strength, adhesive tensile strength, electrical conductivity and electrochemical properties such as electrolytic conductivity, polarization resistance, galvanic activity of embedded metal electrodes, of compounds can be specifically modified by admixing and by a content of CQDs.

Embodiments of the invention also relate to the use of the composition according to embodiments of the invention for construction purposes, preferably use in a construction material, particularly preferably in a man-made construction material. Among the uses, most preferred is the use of the composition according to embodiments of the invention in a paint, coating agent, binder, concrete or mortar.

It is understood that the above features and those to be explained below can be used not only in the combinations indicated, but also in other combinations or on their own, without departing from the scope of the present invention.

Embodiments of the invention are explained in more detail in the following examples, but without limiting the invention thereto.

### EXAMPLES

### Example 1

An electrically conductive compound anode was fabricated as follows:

A concrete slab 40×40×4 cm was coated on one half 40×19.5 cm with a electrically conductive alumo-silicate containing coating according to EP 1 068 164 A2 (850 g/m²) to which 0.5 wt.-% of a CQD's containing polyoxethylene colloid with a CQD content of 1 wt.-% had been added.

The electrically conductive aluminosilicate-containing coating according to EP 1 068 164 A2 was prepared as follows:

### Component A:

| | Weight |
|---|---|
| Ingredient | parts |
| Water | 12.00 |
| Potassium silicate solution (24.5% SiO₂, 24.8% K₂O) | 200.00 |
| Aqueous 50% dispersion of a polystryrene-acrylic ether | 290.00 |
| copolymer | |
| Methyl hydroxycellulose, M 6000 | 3.00 |
| 30% solution of a polyacrylate-based dispersing agent | 10.00 |
| Butyl glycol | 15.00 |
| Graphite powder | 300.00 |
| Deionized water | 182.00 |

### Component B:

| Ingredient | Weight parts |
|---|---|
| Sodium aluminate | 6.28 |
| Sodium hydroxide | 1.05 |
| Demineralized water | 17.36 |

Component A and component B were mixed in a ratio of 45:1 with stirring.

On the second half of the concrete slab, the same conductive coating with 0.5% of the same polyoxethylene (POE) mixed in was applied as a reference. In each case, 800 g/m² of conductive coating was applied. The coatings were cured at 75% relative humidity for 2 weeks.

After curing, the electrical surface conductivity was measured at 1 KHz with an impedance meter by pressing test probes into the conductive coating with a test probe distance of 5 cm.

After measuring the sheet resistances, the adhesive tensile strengths were determined in accordance with EN 13892-8.

| | Content | | |
|---|---|---|---|
| | wt.-% of | Mean sheet | Medium adhesive |
| Coating | CQD in | resistance | tensile strengths |
| Reference 0.5% POE | 0.000 | 105 Ohm | 0.35 MPa |
| 0.5% POE + CQD | 0.005 | 25 Ohm | 1.20 MPa |

### Example 2

An electrically conductive compound anode was fabricated as follows:

A concrete slab 40×20×4 cm was coated on one side with an electrically conductive alumo-silicate containing coating according to EP 1 068 164 A2, on the opposite side the same conductive coating was applied with a content of CQD's of approx. 0.01 wt. %. The CQD's were added as polyoxyethylene colloid with a CQD content of 2 wt. %. As a reference, the same test specimen was prepared with the same conductive coating on both sides—i.e., a conductive coating without CQD's. In each case, 800 g/m² of conductive coating was applied.

A lead strip (width×thickness=1.5 cm×0.1 cm), which was provided with an adhesive layer on the underside, was embedded in each of the coatings for electrical contact. The coatings were cured at 75% relative humidity for 2 weeks and the coated concrete slabs were then stored at 50% relative humidity for 2 months.

A DC voltage of 2.0 volts was applied between the two coatings across the two lead strips and the current flow was measured across a “shunt” resistor of 100 ohms. From the current flow and the concrete body geometry, the specific resistance was calculated according to Ohm's law:
Spec. resistance (Ohm·cm)=(2 volts×A)/current×L)
A=surface=20×40=800 cm²
L=thickness of the concrete slab=4 cm
Current in amps

| | |
|---|---|
| 0.01 wt. % CQD in | |
| conductive coating | Reference |

R_{Beton} [kOhm · cm]

| | | |
|---|---|---|
| START | 759 | 3226 |
| after 10 days @50% RH | 1023 | 3200 |
| after 60 days @50% RH | 1498 | 4878 |

The admixture of CQD's to the conductive coating caused a significant decrease of the DC resistance between the anodically and cathodically polarized electrodes consisting of the conductive coating. This is equivalent to a significant decrease in polarization resistance under dry conditions (50% relative humidity) by admixing small amounts of CQDs.

After completion of the resistance measurements, the adhesive tensile strengths (HZF) of the conductive coating were measured:

| HZF measured | 0.02 wt. % CQD in | | | | |
|---|---|---|---|---|---|
| after 85 days | conductive coating | | Reference | | Comment |
| | 1.69 | MPa | 1.16 | MPa | Break 100% |
| | 1.75 | MPa | 1.43 | MPa | in coating |
| | 1.64 | MPa | 1.38 | MPa | |
| Mean value | 1.69 ± 0.05 | MPa | 1.32 ± 0.12 | MPa | |

The tensile mixing of CQD's caused an increase in the adhesion of the conductive coating to the concrete.

### Example 3

Analogous to example 2, concrete slabs L×W×H=40×20×4 cm were coated with compound anodes.

However, before the conductive coating was applied, a so-called primer, also known as undercoat, was applied. As is known to the skilled person, when coating concrete surfaces with mortar, organic coatings, foils, etc., a primer, also known as a undercoat, is applied to increase adhesion. The primer does not form a coating, but is absorbed by the concrete cover capillary—the concrete surface is impregnated with the primer. The primer used was an alkaline aqueous potassium silicate solution (24.5% SiO₂, 24.8% K₂O) diluted 1:6 with water.

In each case 200 g primer/m² concrete surface was applied. The conductive coating was applied 24 hours after application of the primer as described in Example 2. The underside of the concrete slab was coated with the electrically conductive coating without applying a primer. Analogous to Example 2, the DC resistances were determined at 2.0 volts:

| | |
|---|---|
| 0.02 wt. % CQD in | Reference |
| K2O/SiO2 primer | (Without CQD) |

R_{Beton} [kOhm · cm]

| | | |
|---|---|---|
| START | 292 | 901 |
| after 10 days @50% RH | 336 | 1190 |
| after 60 days @50% RH | 576 | 2116 |

This example also shows that an admixture of 0.02 wt. % CQD's leads to a significant decrease in polarization resistance.

### Example 4

Analogous to Example 2, concrete slabs L×W×H=40×20×4 cm were coated with the compound coating. Before applying the conductive coating, a primer was applied as in Example 3. As described in Example 3, an alkaline aqueous solution of potassium silicate was used as primer. In each case, 200 g primer/m² of concrete surface was applied. The conductive coating was applied 24 hours after application of the primer as described in Example 4. The underside of the concrete slab was coated with the electrically conductive coating without applying a primer.

Analogous to Example 2, the DC resistances were determined at 2.0 volts, and in addition, the impedances at 120 Hz and 1 KHz were also determined:

| | | | Specific resistance [Kohm · cm] | | |
|---|---|---|---|---|---|
| | | | DC - | Impedance | Impedance |
| | | mA/m² | Resistor | 1 KHz | 120 Hz |
| 1 | Reference: Compound | 4.7 | 10 636 | 2.58 | 3.07 |
| | coating | | | | |
| 2 | Primer + 0.05% CQD/ | 8.3 | 6 052 | 2.20 | 2.59 |
| | polyether + compound | | | | |
| | coating | | | | |
| 3 | 0.05% CQD/polyether + | 4.6 | 10 969 | 3.09 | 3.77 |
| | compound coating | | | | |
| 4 | Polyether as primer + | 2.3 | 21 938 | 4.03 | 5.01 |
| | compound coating | | | | |

Comparison of samples 1 (compound coating only) with sample 2 (primer+0.05% CQD/polyether+compound coating) shows a significant reduction in DC resistance. Similarly, comparison of sample 3 (0.05% CQD/polyether as primer+compound coating) with sample 4 (polyether as primer+compound coating) shows a reduction in DC resistance by half. The influence of the CQD's on the AC resistance is significantly lower.

### Example 5

Analogous to example 4, concrete slabs L×W×H=40×20×4 cm were coated with compound anodes.

Before applying the conductive coating, a primer was applied as in Example 3. As described in Example 3, an alkaline aqueous solution of potassium silicate was used as primer. In each case, 200 g primer/m² of concrete surface was applied. The conductive coating was applied 24 hours after application of the primer as described in Example 4. The underside of the concrete slab was coated with the electrically conductive coating without applying a primer.

Analogous to Example 2, the DC resistances at 2.0 volts and the adhesive tensile strengths were determined, and in addition, the impedances were also determined:

| | | | Specific resistance | | |
|---|---|---|---|---|---|
| | | | [kOhm · cm] | | |
| | | | | Imped- | Imped- |
| | | | DC - | ance | ance |
| Sample | | mA/m² | Resistor | 1 kHz | 120 Hz |
| 1 | Primer + compound | 0.61 | 8.131 | 0.66 | 1.58 |
| | coating | | | | |
| 2 | Primer + 0.2% CQD + | 1.71 | 2.925 | 1.19 | 1.33 |
| | compound coating | | | | |
| 3 | Primer + 0.15% CQD + | 1.03 | 4.875 | 1.18 | 1.32 |
| | compound coating | | | | |
| 4 | Primer + 0.1% CQD + | 0.97 | 5.162 | 1.18 | 1.31 |
| | compound coating | | | | |

The results show a clear correlation of the amount of added CQD's and the measured DC resistance. The influence of the CQD's on the AC resistance is significantly lower.

### Example 6

Analogous to Example 4, concrete slabs L×W×H=40×20×4 cm were coated with primer+compound anodes as well as with primer+compound anode containing 0.04% and CQD's. The primer was an alumino-silicate primer. Whereby the primer was an alumino-silicate primer prepared by mixing the alkali silicate primer according to Example 3 with component B according to Example 1 in a mixing ratio of 30:1. Approximately 200 g alumino-silicate primer/m² concrete surface was applied. After a curing time of 14 days, a voltage of 2 volts was applied first, and after stabilization of the measured current, 3 volts were applied. From the measured shunt voltage, the DC current that flowed between the anode and cathode (compound coating on the opposite side of the concrete slab) was calculated, and from this, the specific resistance was calculated. Impedances were measured after the DC current was switched off or the applied voltage was interrupted. Adhesive tensile strengths were measured using a PROCEQ Dyna Z16 and 3M DP 100 epoxy adhesive.

Influence of current and voltage on specific resistance and adhesive tensile strengths, relative humidity: 45%, 20.0° C. temperature

| | | | | | | | Adhesive |
|---|---|---|---|---|---|---|---|
| | | | | | | | tensile |
| | | | | Specific resistance | | | strength |
| | | Applied | DC | [Kohm · cm] | | | after 77 |
| | | voltage | current | DC - | Impedance | Impedance | days |
| | | V | mA/m² | Resistance | 1 KHz | 120 Hz | [MPa] |
| 1 | Primer + compound | 2 | 1.95 | 2.569 | 1.7 | 2.0 | 4.47 ± |
| 2 | coating | 3 | 1.88 | 3.984 | | | 0.25 |
| 3 | Primer + 0.04% | 2 | 2.26 | 2.216 | 1.9 | 2.3 | 5.18 ± |
| 4 | CQD + compound | 3 | 2.30 | 3.260 | | | 0.23 |
| | coating | | | | | | |

The addition of the CQD's causes a significant decrease in the DC resistance while the impedance increases—this indicates that the CQD's primarily decrease the polarization resistance. The CQD's cause a significant increase in adhesive tensile strengths 77 days after application of the compound coating.

### Example 7

To investigate the selective influence of CQD's on anodic and cathodic P, test plates were fabricated and measured as in Example 4. The results show that the CQD's have a significantly stronger effect on the polarization resistance at the cathode than on the polarization resistance at the anode:
Relative humidity: 45%, 20.0° C. temperature, duration of polarization: 10 days

| | | Applied | DC | Specific resistance [Kohm · cm] | | |
|---|---|---|---|---|---|---|
| | | voltage | current | DC - | Impedance | Impedance |
| | | V | mA/m² | Resistance | 1 KHz | 120 Hz |
| 1 | Primer + PEG + | Anode | 0.34 | 21.938 | 4.03 | 5.01 |
| 2 | compound coating | Cathode | 0.38 | 19.558 | | |
| 3 | Primer + PEG + | Anode | 0.91 | 8.227 | 1.18 | 1.31 |
| 4 | 0.08 wt. % CQD | Cathode | 1.27 | 5.929 | | |
| | compound coating | | | | | |

### Example 9

A laboratory-scale galvanic zinc anode was prepared as follows: A concrete test specimen (L×W×H=27×19×5 cm) was made of standard concrete (w/c=0.47, concrete content 350 kg/m³) with a chloride content of 3 wt. % chloride/concrete weight into which a reinforcing steel grid (24×15 cm, consisting of 5 steel bars longitudinally parallel with a diameter of 10 mm and 2 steel bars transversely with a diameter of 6 mm, all steel bars were connected to each other by means of electrofusion) was embedded with a concrete cover of 2 cm. A 6 mm steel bar pro-truded from the concrete test specimen for making an electrical connection to the reinforcing steel grid. The concrete test specimens were stored dry for 1 month at 99% rel. humidity and then for 2 months in the laboratory (RT, rel. humidity approx. 45%).

The concrete test specimen was coated with a binder according to embodiments of the invention, consisting of 2 components and a filler (crushed marble sand 0.2-0.5 mm).

The binder was prepared as follows:

| | | |
|---|---|---|
| 12 | Weight parts | Water |
| 40 | Weight parts | Blast furnace slag 38% CaO, 37% SiO₂, 12% |
| | | Al₂O₃, 96% glass content |
| 25 | Weight parts | Metakaolin |
| 18 | Weight parts | 50% aqueous dispersion copolymer of butyl |
| | | acrylate and styrene |
| 4.4 | Weight parts | Polyethyleneimine |
| 0.1 | Weight parts | Dispersing agent |
| 0.3 | Weight parts | Cellulose Ether |
| 0.2 | Weight parts | Defoamer |

### Component B

| | | |
|---|---|---|
| 40 | Weight parts | Potassium water glass SiO₂/K₂O = 2.05-2.25, content |
| | | 34 wt. %. |
| 60 | Weight parts | Potassium silicate solution SiO₂/K₂O = 0.65, content |
| | | 34 wt. %. |

Mixing ratio A:B:F = 1:0.5:1

A zinc grid anode (99.9% zinc, mesh size 7 mm, wire thickness 1.1 mm) was installed on the concrete test specimen by first applying the binder according to embodiments of the invention with a layer thickness of 2 mm, then placing the zinc grid (26×19 cm) and subsequently embedding the zinc grid by applying a further approx. 4 mm of the binder according to embodiments of the invention. An electrical connection was made by soldering a 1.5 mm² stranded copper wire with a length of approx. 2 m. The copper wire was then connected to the reinforconcrete. Likewise, an electrical connection was made to the reinforcing steel mesh. A binder according to EP 2313352 A1 with a SiO₂/(CaO+MgO+Al₂O₃) ratio of 1.7 and a molar SiO₂/Al₂O₃ ratio of 12 was used to embed the zinc grid. The binder was prepared by mixing 2 liquid components (component A and component B), where component B was mixed with different amounts of CQD's according to embodiments of the invention, and an input of a filler (marble sand 0.2-0.5 mm) with the following mixing ratio: A/B/filler=1/0.5/1. The CQD's were added as colloid—suspended in polyoxyethylene—to component B, in the following amounts:

| | Content wt.-% of CQD in | | |
|---|---|---|---|
| Mixture no. | Polyoxyethylene | Component B | Component A + B |
| 9.1 | 3.64 | 0.15 | 0.10 |
| 9.2 | 1.69 | 0.07 | 0.04 |
| 9.3 | 1.00 | 0.04 | 0.03 |
| 9.4. | 0.09 | 0.004 | 0.002 |

The concentration of the CQD's was determined spectrophotometrically using UV/VIS spectroscopy. The CQD's exhibit an absorption peak at 260 nm with an extinction coefficient of 1.3*10⁶ mol-1 cm-1.

The embedded zinc anode (EZ anode) thus produced and applied to the concrete test specimen was stored for 1 week at 99% relative humidity. After curing of the EZ anode, a one meter long copper strand with a strand cross-section of 1.5 mm² was soldered to each of the anodes using a Sn/Zn solder.

The concrete specimen equipped with the EZ anode was stored at 75% relative humidity. Before commissioning, the electrochemical potentials of the reinforcing steel and the zinc anode were measured. The EZ anode was commissioned by connecting the EZ anode and the rebar as the cathode via the copper strands, with a 0.1 ohm shunt resistor connected in between. An operational amplifier was used to measure the galvanic current flowing between the EZ anode and the rebar and recorded using a data logger.

The following results were obtained:

| Mixture | CQD | Galvanic current in mA/m² concrete surface according to | | | | | |
|---|---|---|---|---|---|---|---|
| no. | content in wt.-% | 1 day | 1 week | 2 weeks | 3 weeks | 1 month | 3 months |
| 9.1. | 0.10 | 45.2 | 29.5 | 20.9 | 16.4 | 14.4 | 6.8 |
| 9.2. | 0.04 | 43.6 | 30.8 | 19.1 | 13.7 | 11.7 | 5.8 |
| 9.3. | 0.03 | 41.6 | 29.2 | 19.0 | 14.6 | 12.1 | 5.0 |
| 9.4. | 0.002 | 35.8 | 17.5 | 13.0 | 11.0 | 9.7 | 5.4 |

The data clearly show that the galvanic currents increase with increasing concentration of CQD's whereby the relation concentration/galvanic current is consistent. Even very low concentrations of CQD's cause a significant increase in galvanic current—an addition of 0.1 wt. % causes an increase in galvanic current of 48%.

The results—low concentration of CQD's with significant effect and consistent correlation with addition amount—suggest that the CQD's surprisingly act as “interface” catalysts—by facilitating charge transfer at the anode surface.

### Example 10

As in Example 9, an EZ anode was applied to a concrete test slab with a chloride content of 3 wt.-%/weight of concrete.

A binder as in Example 9 was used with a SiO₂/(CaO+MgO+Al₂O₃) ratio of 1.5 and a molar SiO₂/Al₂O₃ ratio of 15. The mixing ratio of component A to component B and to the filler (marble sand 0.2-0.5 mm) was 1.0/0.5/1.0, as in Example 9. Specimen 11.1. was prepared by coating with a binder to which a 1.9% CQD colloid was added.

The EZ anode was started up as described in Example 9 and the galvanic currents were recorded at 30 min intervals. The following results were obtained:

| | | Galvanic current in mA/m² concrete | | | |
|---|---|---|---|---|---|
| Mixture | CQD content | surface according to | | | |
| no. | in wt.-% | 1 day | 2 weeks | 1 months | 3 months |
| 11.1. | 0.025 | 27.5 | 30.2 | 21.8 | 18.0 |
| 11.2. | 0.000 | 16.2 | 19.1 | 15.5 | 16.0 |

As in Examples 9 and 10, the addition of CQD's in concentrations of about 0.05 wt.-% causes a significant increase in galvanic currents.

### Example 11

As described in Example 9, an EZ anode was installed on a concrete test slab. The same concrete was used, but without the addition of sodium chloride, thus chloride free.

A binder as in Example 9 was used with a SiOz/(CaO+MgO+Al₂O₃) ratio of 2 and a molar SiO₂/Al₂O₃ ratio of 9. The mixing ratio of component A to component B and to the filler (marble sand 0.2-0.5 mm) was 1.0/0.5/1.0, as in Example 9.

| Mixture | Content wt.-% of CQD in | | |
|---|---|---|---|
| no. | Polyoxyethylene | Component B | Component A + B |
| 10.1 | 1.9 | 0.08 | 0.05 |
| 10.2 | 0.09 | 0.004 | 0.003 |

The EZ anode was started up as described in Example 9 and the galvanic currents were recorded at 30 min intervals. The following results were obtained:

| | | Galvanic current in mA/m² concrete | | |
|---|---|---|---|---|
| Mixture | CQD content | surface according to | | |
| no. | in wt.-% | 3 days | 1 week | 2 weeks |
| 10.1. | 0.05 | 12.6 | 11.7 | |
| 10.2. | 0.003 | 9.0 | 8.1 | |

The addition of 0.05 wt.-% CQD's to the binder results in a 40% increase in galvanic current.

### Example 12

Autocorrosion

### Example 13

### Moisture Sensitivity

### Example 14

One half of each standard concrete slab 40 cm×40 cm×4 cm was coated with the binder described in Example 9 according to EP 2313352 A1 with a layer thickness of 6 mm: On one half (19 cm×40 cm) the binder was applied without CQD—additive, on the second half (19 cm×40 cm) the binder was applied with an addition of 0.04% CQD's.

After 15 days, the adhesive tensile strengths were measured:

| | HZF 1 | HZF 2 | HZF 3 | HZF MW |
|---|---|---|---|---|
| Without CQD | 0.25 MPa | 0.21 MPa | 0.25 MPa | 0.24 MPa |
| With 0.04% CQD | 0.42 MPa | 0.37 MPa | 0.42 MPa | 0.40 MPa |

Even a very small addition of CQD's causes a significant increase in the adhesion of the cured binder to the concrete substrate.

### Example 15

One half of each standard concrete slab 40 cm×40 cm×4 cm was coated with the binder according to EP 2313352 A1 described in Example 9 with a layer thickness of 6 mm, as described in Example 14: On one half (19 cm×40 cm) the binder was applied without CQD addition but with a poly-alkyl ether addition of 1.33 wt. %, on the second half (19 cm×40 cm) the binder was applied with poly-alkyl ether addition and additionally with an addition of 0.03% CQDs.

After 15 days, the adhesive tensile strengths were measured:

| | HZF 1 | HZF 2 | HZF 3 | HZF MW |
|---|---|---|---|---|
| Without CQD | 0.18 MPa | 0.19 MPa | 0.18 MPa | 0.18 MPa |
| With 0.03% CQD | 0.42 MPa | 0.42 MPa | 0.37 MPa | 0.40 MPa |

After 28 days, the following adhesive tensile strengths were measured:

| | HZF 1 | HZF 2 | HZF 3 | HZF MW |
|---|---|---|---|---|
| Without CQD | 0.34 MPa | 0.31 MPa | 0.33 MPa | 0.33 MPa |
| With 0.03% CQD | 1.09 MPa | 0.98 MPa | 0.90 MPa | 1.0 MPa |

Even a very small addition of CQD's causes a significant increase in the adhesion of the cured binder to the concrete substrate.

1. A composition for construction purposes comprising 0.001-2 wt.-% carbon quantum dots, based on the total weight of the composition.

2. The composition according to claim 1, characterized in that the composition is a paint, coating agent, binder, concrete or mortar.

3. The composition according to claim 1, characterized in that the composition comprises 0.005-0.5 wt.-%, preferably 0.05-0.2 wt.-%, of carbon quantum dots, based on the total weight of the composition.

4. The composition according to claim 1, characterized in that the composition is liquid and cures at room temperature within one week.

5. The composition according to claim 1, characterized in that the composition contains one or more compounds selected from the group composed of silicate, silicium dioxide, aluminate, aluminosilicate, graphite, carbonate, resin, silicone, cellulose and organic polymer.

6. The composition according to claim 5, characterized in that the composition contains at least 30 wt.-% of the one or more compounds, based on the total weight of the composition.

7. The composition according to claim 1, characterized in that the composition comprises one or more aluminosilicates having the formula aM₂O*bAl₂O₃*cSiO₂, wherein the molar ratio c/b is 0.1-15 and the molar ratio a/b is 0, 2-10, with M=Li, Na, K and/or characterized in that the composition comprises one or more aluminosilicates comprising calcium, wherein the molar ratio SiO₂/Al₂O₃ is <25 and the molar ratio SiO₂/(CaO+Al₂O₃) is <10.

8. The composition according to claim 1, characterized in that the carbon quantum dots fluoresce upon stimulation with UV light in the wavelength band 400 to 600 nm.

9. The use of a composition according to claim 1 in a construction material.

10. The use of a composition according to claim 1 in a paint, coating agent, binder, concrete or mortar.
